(19) United States
(12) Patent Application Publication
(10) Pub. No.: US 2012/0237726 A1
(43) Pub. Date: Sep. 20, 2012

(54) IN-MOLD MOLDED PRODUCT, IN-MOLD MOLDING FILM, AND METHOD FOR PRODUCING IN-MOLD MOLDED PRODUCT

(75) Inventors: Kazuhiko KANEUCHI, Osaka (JP); Gakuei SHIBATA, Osaka (JP)

(73) Assignee: PANASONIC CORPORATION, Osaka (JP)

(21) Appl. No.: 13/416,666

(22) Filed: Mar. 9, 2012

(30) Foreign Application Priority Data
Mar. 18, 2011 (JP) 2011-059959

(51) Int. Cl. B32B 3/00; B32B 3/26; B32B 7/02; B29C 39/10; B32B 7/12

(52) U.S. Cl. 428/141; 156/246; 428/343; 428/218; 428/213; 428/304.4

(57) ABSTRACT

An in-mold molded product according to the present invention includes: molded resin; a transfer film including an adhesive layer in contact with the molded resin; and a plurality of filler pieces, at least a part of volumes of the filler pieces being contained in the adhesive layer.

The disclosure of Japanese Patent Application No. 2011-059959 filed Mar. 18, 2011 including specification, drawings and claims is incorporated herein by reference in its entirety.

### FIELD OF THE INVENTION

The present invention relates to an in-mold molded product including a surface and a transfer film on the surface, an in-mold molding film, and a method for producing an in-mold molded product.

### BACKGROUND OF THE INVENTION

In-mold molding is a method for decorating a surface of molded resin with, design such as color, picture or pattern, or forming a UV coating layer or a conductive film on the surface.

Specifically, in-mold molding is a method for conveying a transfer film including, for example, a coloring layer on which various pictures are printed, or a functional layer to be a UV coating layer or a conductive film into a mold by a carrier film, mounting the transfer film to the mold, then injecting injection molding resin toward the transfer film in the mold, and integrally molding the transfer film and the injection molding resin in the mold.

The in-mold molding is used for producing exterior molded products of audio-visual equipment such as television sets or audio devices or cellular phones, or exterior molded members of automobiles.

However, in the conventional in-mold molding, a foil burr is easily generated at an end or end surface of a molded product, and this requires a step of processing the foil burr after injection molding. A method for processing a foil burr includes a manually processing method and a processing method using a dedicated jig. Japanese Patent Laid-Open No. 2001-260168 discloses a method for processing a foil burr using a dedicated jig.

Now, with reference to FIGS. 17, 18, 19A and 19B, a conventional method for processing a foil burr using a dedicated jig will be described.

FIG. 17 shows a layer configuration of a conventional decorative film for in-mold molding. The decorative film is an in-mold molding film used for decorating a surface of a molded product.

As shown in FIG. 17, a decorative film 111 mainly includes a carrier film 201 that is not transferred to a molded product, and a transfer film 202 that is transferred to a surface of the molded product.

A decorative film 111 will be further described in detail. A carrier film 201 includes a base film 301 made of a PET or an acrylic film, or the like that continuously supplies a decorative film 111 (transfer film 202) into a mold, and a delamination layer 302 for delaminating the transfer film 202 from the base film 301. Also, the transfer film 202 transferred to the surface of a molded product includes a protective layer or hard coat layer 303, an anchor layer 304, a coloring layer 305, and an adhesive layer 306. The protective layer or hard coat layer 303 protects the transfer film 202 from flaw or dust on an outermost surface of an in-mold molded product. The anchor layer 304 connects the protective layer or hard coat layer 303 and the coloring layer 305. The coloring layer 305 provides design such as color, picture, or pattern on the surface of the molded product. The adhesive layer 306 bonds the transfer film 202 to injection molding resin. As described above, the decorative film 111 includes a plurality of layers.

Next, with reference to FIG. 18, a process for producing an in-mold molded product will be described. FIG. 18 shows a process for producing an in-mold molded product having a surface decorated with a decorative film. A process of producing an in-mold molded product including a surface and a UV coating layer or a conductive film formed on the surface using an in-mold molding film including a functional layer to be a UV coating layer or a conductive film is the same as described below.

First, in step S1, the decorative film 111 is fed by a foil feeding device (not shown) so that predetermined design such as color, picture, or pattern applied on a coloring layer is placed in a predetermined position between a stationary mold 1 and a movable mold 2. At this time, the decorative film 111 is fed so that the base film 301 faces the movable mold 2, and the adhesive layer 306 faces the stationary mold 1.

After the decorative film 111 is placed between the stationary mold 1 and the movable mold 2, in step S2, the movable mold 2 is moved to clamp the stationary mold 1 and the movable mold 2.

Next, in step S3, molten injection molding resin 4 is injected from a gate 3 of the stationary mold 1 toward the adhesive layer of the decorative film 111, and the molten injection molding resin 4 is poured into a cavity formed by clamping the stationary mold 1 and the movable mold 2. Thus, the molten injection molding resin 4 fills the cavity.

After filling of the molten injection molding resin 4 is completed, in step S4, the molten injection molding resin 4 is cooled to a predetermined temperature and hardened.

Then, in step S5, the movable mold 2 is moved to open the stationary mold 1 and the movable mold 2. At this time, the transfer film 202 adhered to the surface of the hardened (molded) injection molding resin 4 is delaminated from the carrier film 201. Thus, an in-mold molded product 5 having a surface of the molded resin to which only the transfer film 202 is transferred can be obtained. The obtained in-mold molded product 5 is coated with the protective layer or hard coat layer of the transfer film 202.

After the mold is opened, an ejection pin 6 is pushed out through the stationary mold 1 to take out the in-mold molded product 5. The taken-out in-mold molded product 5 has a sprue portion 5a unnecessary for a product in a part to be an end product.

In the production process described above, when the transfer film 202 adhering to the surface of the injection molding resin 4 is delaminated from the carrier film 201 (step S5), the transfer film is not cleanly delaminated at an end or end surface of the in-mold molded product 5, then a part of the transfer film that does not need to be transferred is also delaminated from the carrier film 201, sticks to the end or end surface of the in-mold molded product 5, and remains in the in-mold molded product 5 in some cases. The part of the transfer film that remains at the end or end surface of the in-mold molded product 5 and does not need to be transferred is a foil burr 308. In step S5 in FIG. 18, a foil burr 308 generated at the end or end surface of the molded product is shown in an enlarged view of a part Q.

As a method for processing a foil burr in the case where no extra machining allowance is provided other than the sprue portion during production of an in-mold molded product, a method of using a cutter knife or the like to manually cut off, from the molded product, a foil burr remaining at an end surface of a part to be an end product of the in-mold molded product taken out from a mold is generally used.

Also, as shown in FIGS. 19A and 19B, an extra machining allowance portion 8b may be provided on an outside of an end product portion 8a of a molded product 8. In this case, a cutting step for cutting off the unnecessary machining allowance portion 8b from an end product portion 8a is required. In this cutting step, a pair of cutters 7 as shown in FIGS. 19A and 19B are used as a cutting jig.

The cutter 7 includes a cutting tooth 7a and a mount 7b to which the cutting tooth 7a is secured, and the cutting tooth 7a is placed to fit a size of the end product portion 8a. Specifically, as shown in FIG. 19B, a cutting position corresponds to an inclined surface 8c provided between the end product portion 8a and the machining allowance portion 8b.

In the case where the pair of cutters 7 as a cutting jig shown in FIG. 19A are used to cut off the unnecessary machining allowance portion 8b from the end product portion 8a, as shown in FIG. 19B, the cutting teeth 7a of the pair of cutters 7 hold the molded product 8 therebetween at the inclined surface 8c of the molded product 8 as the cutting position. Thus, the machining allowance portion 8b can be cut off from the molded product 8 to obtain an end product.

### DISCLOSURE OF THE INVENTION

As described above, in the conventional method for producing an in-mold molded product, a foil burr is easily generated, and a post-process for processing the foil burr of the molded product is required. This increases the cost for the post-process. Also, in the case where it is difficult to process only the foil burr, the method of providing the machining allowance and cutting the end of the molded product after injection molding is used. This method also requires a post-process for cutting the machining allowance, and further, a material for molding the extra machining allowance is required. This increases the cost for the post-process and the material forming the machining allowance.

The present invention has an object to provide an in-mold molded product, an in-mold molding film, and a method for producing an in-mold molded product, which eliminates a burr processing after injection molding, and also eliminates an extra machining allowance.

To achieve the object, the in-mold molded product of the present invention includes: molded resin; a transfer film including an adhesive layer in contact with the molded resin; and a plurality of filler pieces, at least a part of volumes of the filler pieces being contained in the adhesive layer.

In the in-mold molded product of the present invention, a density of the filler pieces at an end of the transfer film may be higher than a density of the filler pieces at a middle of the transfer film.

In the in-mold molded product of the present invention, an average particle size of the plurality of filler pieces may be larger than a thickness of a thickest part of the adhesive layer of the transfer film.

In the in-mold molded product of the present invention, the adhesive layer of the transfer film may have an irregular surface.

In the in-mold molded product of the present invention, at least a part of a volume of at least one of the filler pieces may be embedded in the molded resin.

In the in-mold molded product of the present invention, at least a part of the plurality of filler pieces may be porous filler pieces.

In the in-mold molded product of the present invention, at least a part of the plurality of filler pieces may be inorganic filler pieces.

An in-mold molding film of the present invention includes: a carrier film; a transfer film including an adhesive layer and formed on the carrier film; and a plurality of filler pieces, at least a part of volumes of the filler pieces being contained in the adhesive layer.

In the in-mold molding film of the present invention, an average particle size of the plurality of filler pieces may be larger than a thickness of a thickest part of the adhesive layer of the transfer film.

In the in-mold molding film of the present invention, the adhesive layer of the transfer film may have an irregular surface.

In the in-mold molding film of the present invention, at least a part of the plurality of filler pieces may be porous filler pieces.

In the in-mold molding film of the present invention, at least a part of the plurality of filler pieces may be inorganic filler pieces.

In the in-mold molding film of the present invention, the transfer film may sequentially include a protective layer or hard coat layer, an anchor layer, a coloring layer, and the adhesive layer, and the carrier film may sequentially include a base film, and a delamination layer.

A method for producing an in-mold molded product of the present invention includes the steps of: placing an in-mold molding film including a carrier film, a transfer film including an adhesive layer and formed on the carrier film, and a plurality of filler pieces, at least a part of volumes of the filler pieces being contained in the adhesive layer, between a first mold and a second mold; clamping the first mold and the second mold; pouring resin into a cavity formed by clamping the first mold and the second mold; cooling the resin poured into the cavity; opening the first mold and the second mold to delaminate the transfer film in contact with the molded resin from the carrier film; and obtaining an in-mold molded product including a surface and the transfer film on the surface, wherein the obtained in-mold molded product includes the molded resin, the transfer film including the adhesive layer in contact with the molded resin, and the plurality of filler pieces, at least a part of volumes of the filler pieces being contained in the adhesive layer.

In the method for producing an in-mold molded product of the present invention, a density of the filler pieces in the transfer film along a cavity surface of one of the first mold and the second mold may be higher at an end of the cavity than at a middle of the cavity in cooling the resin poured into the cavity.

In the method for producing an in-mold molded product of the present invention, in a case where a relationship between distances A and B from a gate for pouring the resin into the cavity is A<B in the cavity when a density of the filler pieces in a position of the distance A from the gate is dA, and a density of the filler pieces in a position of the distance B from the gate is dB, a relationship between the densities dA and dB of the filler pieces may be dA<dB in cooling the resin poured into the cavity.

In the method for producing an in-mold molded product of the present invention, the transfer film may be cut between adjacent filler pieces at the end of the cavity when the first mold and the second mold are opened.

In the method for producing an in-mold molded product of the present invention, at least a part of a volume of at least one of the filler pieces may be embedded in the resin poured into the cavity.

According to the present invention, the adhesive layer of the transfer film placed to face the gate of the mold contains the filler pieces, thereby preventing the generation of a foil burr at the end or end surface of the molded product during production of the in-mold molded product. This can eliminate a step of processing a foil burr after injection molding, and eliminate an extra machining allowance.

Specifically, during injection molding, molten injection molding resin comes into contact with the adhesive layer of the transfer film placed to face the gate of the mold to soften the adhesive layer formed of thermoplastic resin, and the resin forming the adhesive layer flows in the adhesive layer in synchronization with a flow of the molten injection molding resin. Thus, when the adhesive layer contains the filler pieces, the filler pieces mixed in the adhesive layer flow toward the end of the cavity of the mold by the flow of the resin in the adhesive layer during injection molding. As a result, when filling of the molten injection molding resin is completed, the density of the filler pieces is high at the end of the cavity of the mold, and also the density of the resin forming the adhesive layer is low at the end of the cavity of the mold. Therefore, adhesive strength (bonding strength) between adjacent filler pieces is low at the end of the cavity of the mold. Thus, a crack is easily generated in the adhesive layer of the transfer film at the end of the cavity of the mold. Thus, when the injection molding resin in the mold is sufficiently cooled and the mold is opened, a crack is generated between adjacent filler pieces at the end or end surface of the molded product, and a break occurs from the crack in the adhesive layer between a region of the transfer film transferred to a surface of the molded product and a region of the transfer film that is not transferred to the surface of the molded product to cause foil separation of the transfer film.

As described above, the filler pieces are mixed in the adhesive layer of the transfer film, and thus a break easily occurs in the transfer film at the end or end surface of the molded product when the transfer film adhering to the surface of the injection molding resin is delaminated from the carrier film. This prevents the generation of a foil burr at the end or end surface of the molded product. Therefore, according to the present invention, a step of processing a foil burr may be eliminated, and a dedicated jig for processing a foil burr may be eliminated.

### BRIEF DESCRIPTION OF THE DRAWINGS

FIG. 1 is a sectional view showing a decorative film for in-mold molding in Embodiment 1 of the present invention;

FIG. 2 is a sectional view of a production process of an in-mold molded product in Embodiment 1 of the present invention;

FIG. 3 is a sectional view of a part of steps of a production process of an in-mold molded product in Embodiment 1 of the present invention, and a partial enlarged sectional view thereof;

FIG. 4 is a sectional view of a part of steps of the production process of the in-mold molded product in Embodiment 1 of the present invention, a partial enlarged sectional view thereof, and a partial enlarged plan view thereof;

FIG. 5 is a sectional view of a part of steps of the production process of the in-mold molded product in Embodiment 1 of the present invention, a partial enlarged sectional view thereof, and a partial enlarged plan view thereof;

FIG. 6 is an enlarged sectional view of the in-mold molded product in Embodiment 1 of the present invention;

FIG. 7 is a sectional view of a part of steps of a production process of an in-mold molded product in Embodiment 2 of the present invention, and a partial enlarged sectional view thereof;

FIG. 8 is a sectional view of a part of steps of the production process of the in-mold molded product in Embodiment 2 of the present invention, a partial enlarged sectional view thereof, and a partial enlarged plan view thereof;

FIG. 9 is a sectional view of a part of steps of the production process of the in-mold molded product in Embodiment 2 of the present invention, a partial enlarged sectional view thereof, and a partial enlarged plan view thereof;

FIG. 10 illustrates a decorative film for in-mold molding being rolled up in Embodiment 2 of the present invention;

FIG. 11 is a sectional view of a decorative film for in-mold molding in Embodiment 3 of the present invention;

FIG. 12 is a sectional view of a part of steps of a production process of an in-mold molded product in Embodiment 3 of the present invention, and a partial enlarged sectional view thereof;

FIG. 13 is a sectional view of a part of steps of the production process of the in-mold molded product in Embodiment 3 of the present invention, and a partial enlarged sectional view thereof;

FIG. 14 is a sectional view of a part of steps of the production process of the in-mold molded product in Embodiment 3 of the present invention, and a partial enlarged sectional view thereof;

FIG. 15 is a sectional view of a part of steps of the production process of the in-mold molded product in Embodiment 3 of the present invention, and a partial enlarged sectional view thereof;

FIG. 16 illustrates a decorative film for in-mold molding being rolled up in Embodiment 3 of the present invention;

FIG. 17 is a sectional view of a conventional decorative film for in-mold molding;

FIG. 18 is a sectional view of a conventional production process of an in-mold molded product; and

FIGS. 19A and 19B illustrate a conventional jig for processing a foil burr.

### DESCRIPTION OF THE EMBODIMENTS

Now, embodiments of the present invention will be described with reference to the drawings. The same components will be denoted by the same reference numerals, and overlapping descriptions will be omitted in some cases. The drawings schematically show components for ease of understanding. The thicknesses, lengths, numbers, or the like of the shown components are different from actual ones for convenience of preparation of the drawings.

In embodiments below, a decorative film is used as an example of an in-mold molding film. However, the in-mold molding film is not limited to the decorative film described below. The present invention may be applied to a decorative film having a layer configuration different from that of the decorative film described below, or an in-mold molding film for transferring a functional layer such as a UV coating layer to a surface of a molded product.

The embodiments described below may be combined arbitrarily.

### Embodiment 1

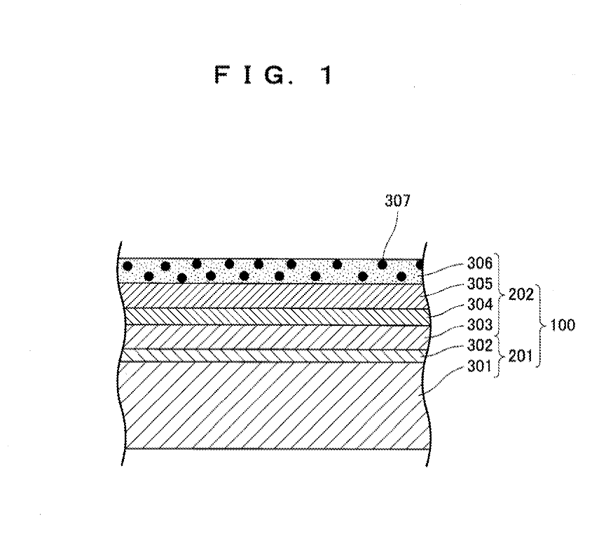

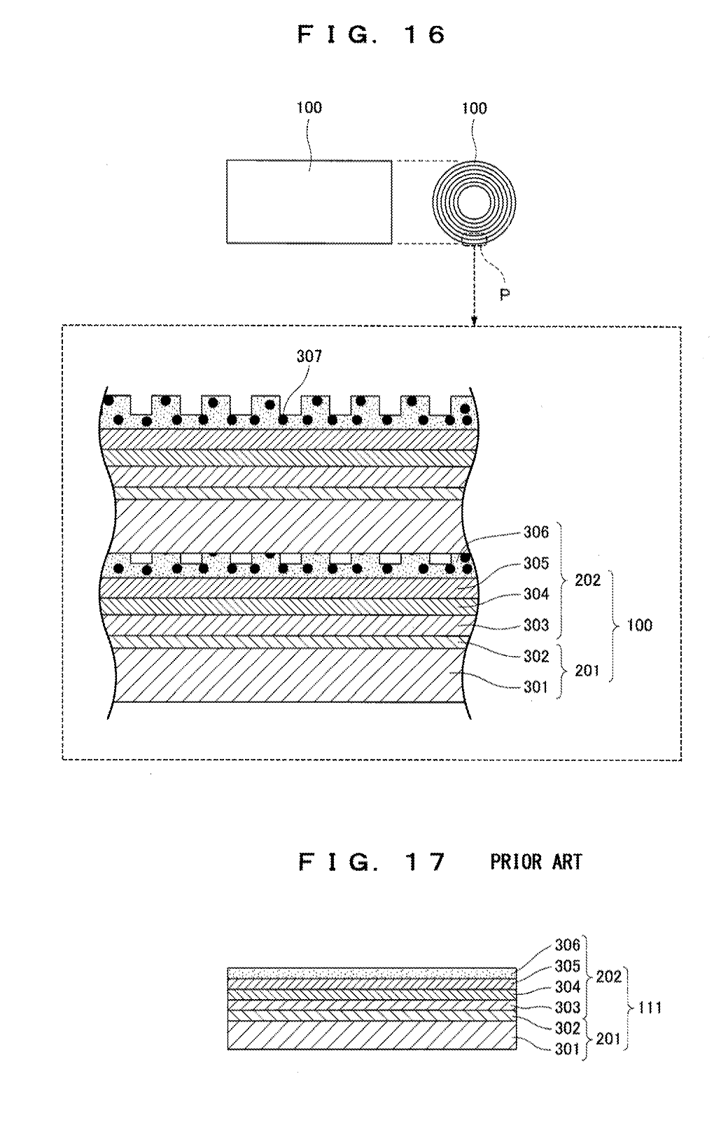

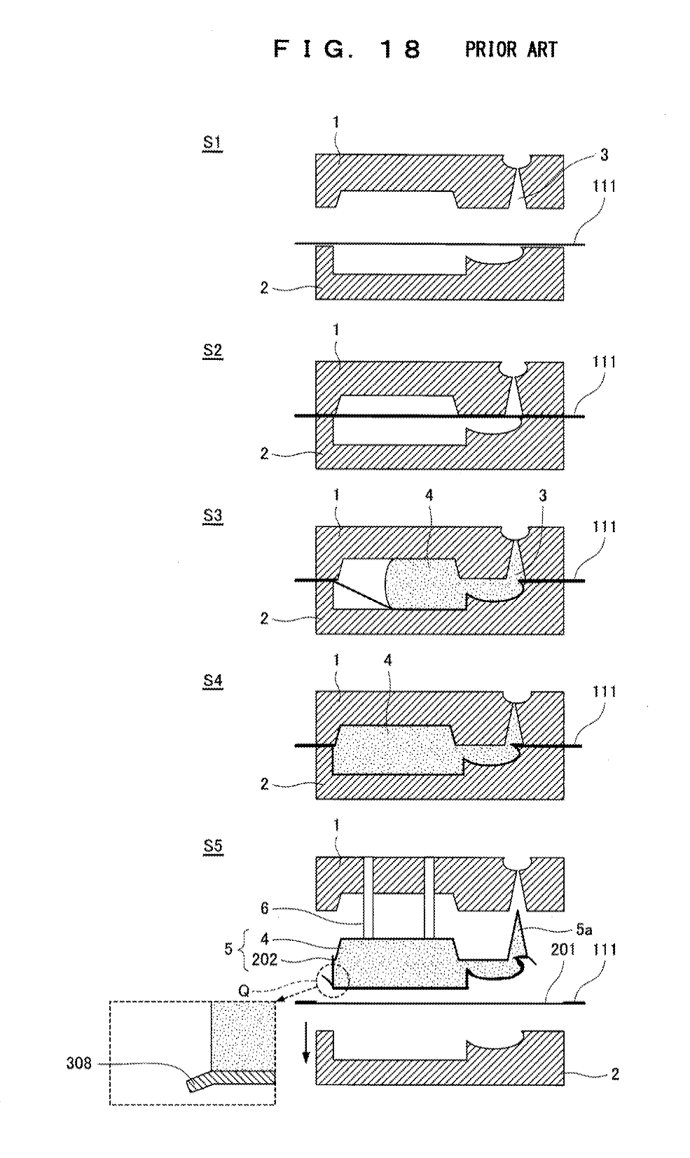

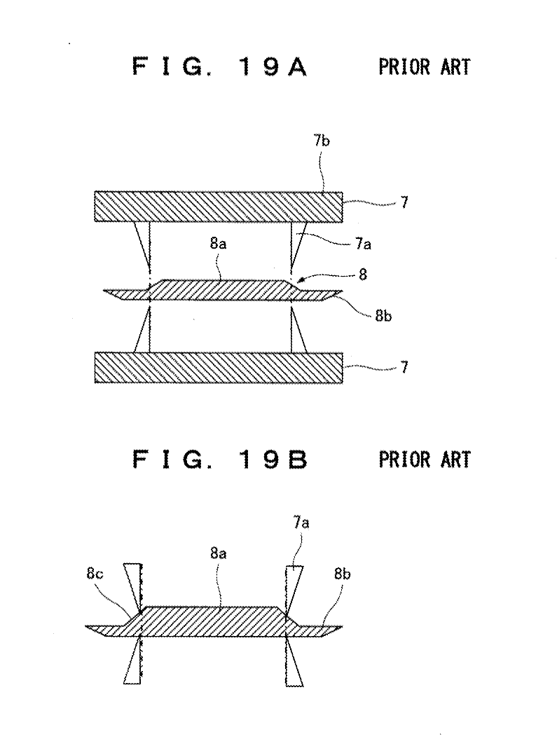

FIG. 1 shows a layer configuration of a decorative film for in-mold molding in Embodiment 1 of the present invention. In FIG. 1, components corresponding to components shown in FIGS. 17 and 18 are denoted by the same reference numerals, and overlapping descriptions will be omitted.

A decorative film 100 shown in FIG. 1 is a continuous film including a carrier film 201 and a transfer film 202.

The carrier film 201 includes a base film 301 and a delamination layer 302. A thickness of the base film 301 is generally selected from a range of 20 μm to 100 μm. In Embodiment 1, a base film 301 having a thickness of 50 μm is used. The delamination layer 302 is formed on the base film 301 so that an average thickness is about 3 μm after drying.

The transfer film 202 is generally formed to have a thickness selected from a range of 2 μm to 50 μm. In Embodiment 1, the transfer film 202 is formed so that a thickest part after drying is about 22 μm. Specifically, layers that constitute the transfer film 202 are formed so that average thicknesses after drying are 5 μm for a protective layer or hard coat layer 303, 3 μm for an anchor layer 304, 10 μm for a coloring layer 305, and 4 μm for an adhesive layer 306. For the protective layer or hard coat layer 303, a UV after curable layer is used.

In the decorative film 100 in Embodiment 1, inorganic filler pieces 307 are contained in the adhesive layer 306 of the transfer film 202.

The inorganic filler piece 307 to be added to the adhesive layer 306 is preferably made of silica or talc that is translucent and does not affect design formed on a surface of a molded product by the coloring layer 305. However, the inorganic filler piece 307 is not limited to silica or talc. The inorganic filler piece 307 may be made of a material that can prevent a generation of a foil burr at an end or end surface of the molded product.

A method for producing the inorganic filler piece 307 is not particularly limited as long as the method can produce an inorganic filler piece that can prevent the generation of a foil burr at an end or end surface of the molded product. For example, silica includes spherical silica, colloidal silica, ground silica, porous silica, or the like depending on machining methods. However, a method for machining silica is not particularly limited as long as the method can produce silica that can prevent the generation of a foil burr at an end or end surface of the molded product.

In Embodiment 1, as the inorganic filler piece 307, spherical silica having an average particle size (catalogue value) of 2 μm is mixed in an adhesive, and then the adhesive is used to form an adhesive layer 306 having an average thickness after drying of 4 μm. The adhesive layer 306 after drying has a thickness of about 5 μm at a thickest part and about 3.5 μm at a thinnest part. Urethane type thermoplastic resin is used as the adhesive forming the adhesive layer 306. In particular, 2 parts by weight of inorganic filler pieces 307 are mixed in 100 parts by weight of adhesive, and then the adhesive layer 306 is formed by screen printing.

For a relationship between the number of added inorganic filler pieces 307 and viscosity of the adhesive, even the same number of inorganic filler pieces 307 are added to the adhesive, the viscosity of the adhesive differs depending on types of the adhesive and average particle sizes of the inorganic filler piece 307, therefore it is not necessarily appropriate to conclude that, generally, when the number of added inorganic filler pieces 307 increase, the viscosity of adhesive tends to increase. A highly viscous adhesive is difficult to handle in printing or coating. It has been found that when spherical silica having an average particle size of 2 μm is used as the inorganic filler piece 307 as in Embodiment 1, 0.5 to 30 parts by weight of inorganic filler pieces 307 are preferably mixed in 100 parts by weight of adhesive in terms of viscosity. Inorganic filler pieces having different average particle sizes may be mixed in the adhesive in terms of adjustment of viscosity.

The adhesive may be mainly made of thermoplastic resin. Thermoplastic resin as main material of the adhesive may be selected from acrylic resin, vinyl chloride resin, or the like according to compatibility with material used for a layer adjacent to the adhesive layer 306.

As a method for forming the adhesive layer 306 using the adhesive containing the inorganic filler piece 307, a printing method such as screen printing, gravure printing, or inkjet printing using a printer, or a coating method using a coater, which are general methods used for forming an adhesive layer of a decorative film or a layer other than the adhesive layer of the decorative film, may be used. However, a preferable range of viscosity of the adhesive differs depending on methods for forming the adhesive layer 306. Thus, the viscosity of the adhesive is adjusted according to the method for forming the adhesive layer.

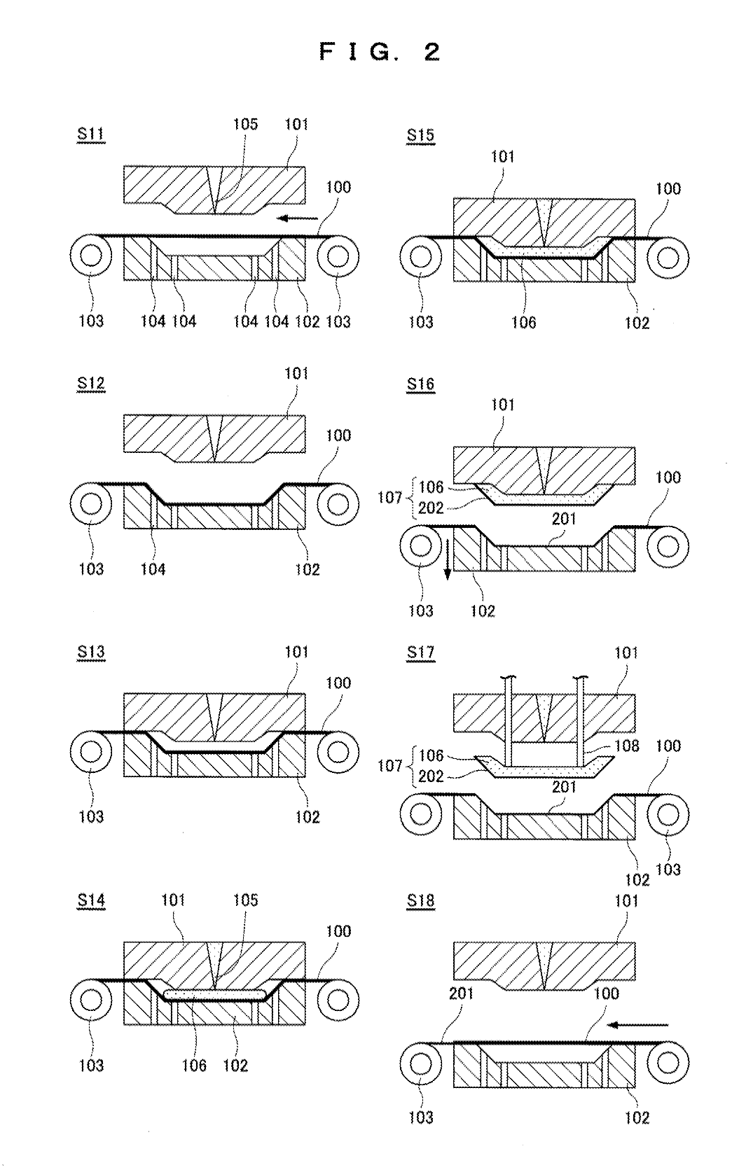

Next, with reference to FIG. 2, a production process of an in-mold molded product using the decorative film 100 described above will be described. In FIG. 2, components corresponding to components shown in FIGS. 1, 17 and 18 are denoted by the same reference numerals, and overlapping descriptions will be omitted.

FIG. 2 shows a process for producing an in-mold molded product having a decorated surface using the decorative film 100 in Embodiment 1.

First, in step S11, the decorative film 100 is fed by a foil feeding device 103 so that predetermined design such as color, picture, or pattern formed on the coloring layer 305 is placed in a predetermined position between a stationary mold 101 as an example of a first or second mold and a movable mold 102 as an example of the second or first mold. The decorative film 100 is fed so that the base film 301 faces the movable mold 102, and the adhesive layer 306 faces the stationary mold 101.

After the decorative film 100 is fed, in step S12, the decorative film 100 is sucked through a suction hole 104 opened in a cavity surface of the movable mold 102 to mount the decorative film 100 to the cavity surface of the movable mold 102. Thus, the cavity surface is shaped by the decorative film 100. At this time, the decorative film 100 is preferably secured and positioned by a film retaining mechanism although it is not shown.

Then, in step S13, the movable mold 102 is moved to clamp the stationary mold 101 and the movable mold 102.

Next, in step S14, molten injection molding resin 106 is injected from a gate 105 of the stationary mold 101 toward the adhesive layer 306 of the decorative film 100, and a cavity formed by clamping the stationary mold 101 and the movable mold 102 is filled with the injection molding resin 106.

After filling of the molten injection molding resin 106 is completed, in step S15, the injection molding resin 106 is cooled to a predetermined temperature. Thus, the injection molding resin 106 is hardened in the cavity.

Then, in step S16, the movable mold 102 is moved to open the stationary mold 101 and the movable mold 102. At this time, the transfer film 202 adhering to the surface of the hardened (molded) injection molding resin 106 is delaminated from the carrier film 201. Thus, an in-mold molded product 107 is obtained which is formed of the molded injection molding resin 106 and has a surface to which only the transfer film 202 is transferred. The protective layer or hard coat layer 303 of the transfer film 202 is placed on an outermost layer of the in-mold molded product 107, and the in-mold molded product 107 is coated with the protective layer or hard coat layer 303.

Then, in step S17, an ejection pin 108 is pushed out through the stationary mold 101 to take out the in-mold molded product 107.

After taking-out of the in-mold molded product 107 is completed, in step S18, adhesion of the decorative film 100 (carrier film 201) to the cavity surface by suction through the suction hole 104 in the movable mold 102 is stopped in preparation for next molding, and then the foil feeding device 103 feeds the decorative film 100. Thus, predetermined design such as color, picture, or pattern formed on the coloring layer 305 and used for the next molding is placed in a predetermined position between the stationary mold 101 and the movable mold 102.

The operations described above are repeated to continuously produce the in-mold molded products.

As described above, the production process of the in-mold molded product using the decorative film 100 in Embodiment 1 is basically the same as the conventional production process shown in FIG. 18.

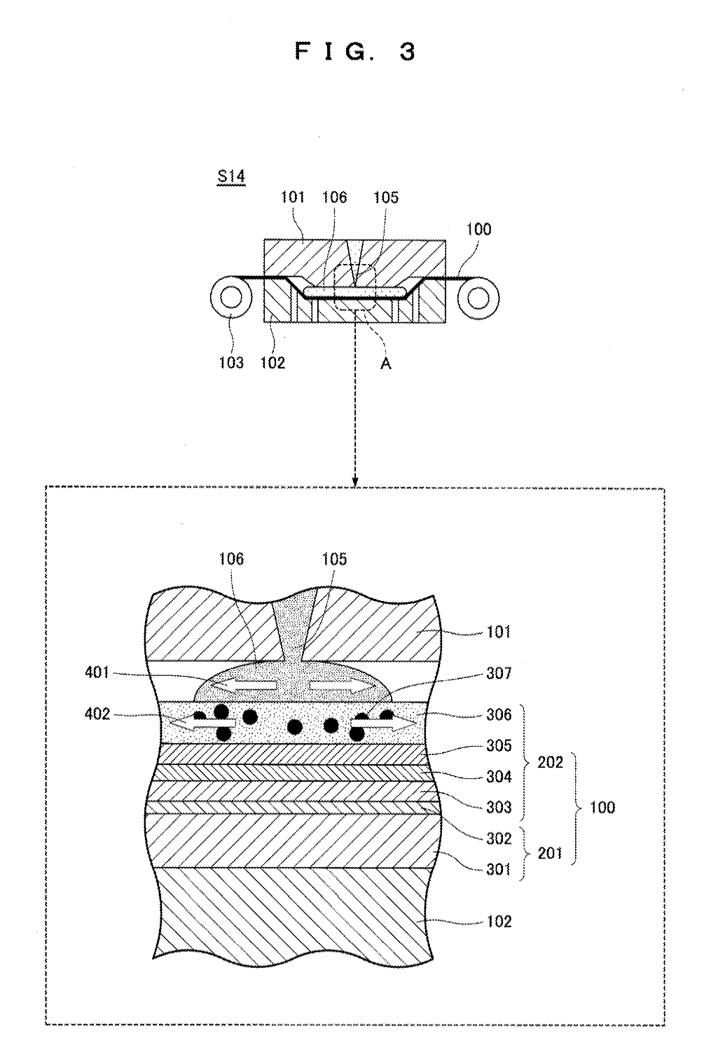

Next, with reference to FIGS. 3 to 5, using the decorative film 100 in Embodiment 1 to prevent the generation of a foil burr at the end or end surface of the molded product will be described. In FIGS. 3 to 5, components corresponding to components shown in FIGS. 1, 2, 17 and 18 are denoted by the same reference numerals, and overlapping descriptions will be omitted.

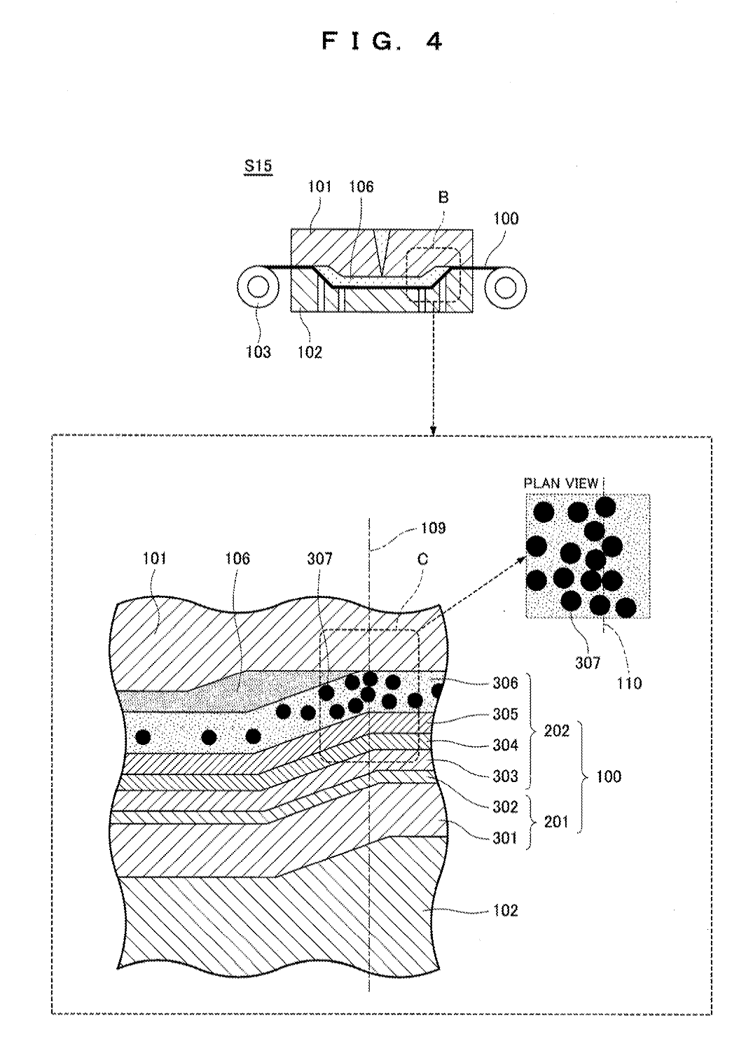

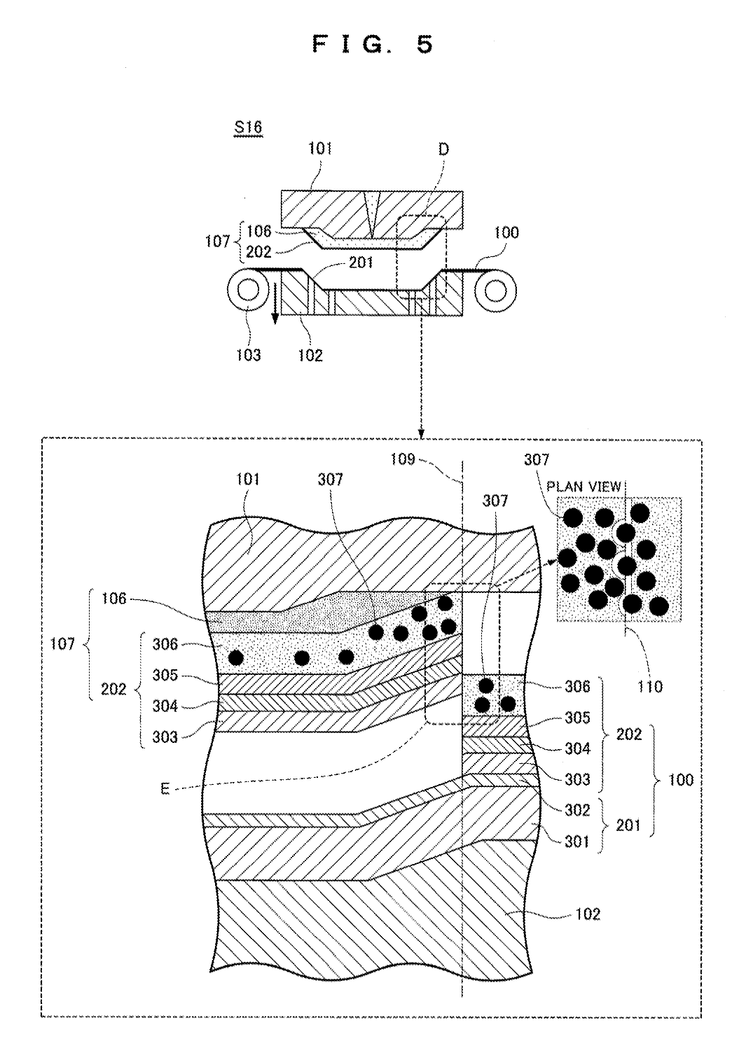

FIG. 3 is a sectional view of step S14 in FIG. 2, and an enlarged sectional view of a part A in the sectional view. FIG. 4 is a sectional view of step S15 in FIG. 2, an enlarged sectional view of a part B in the sectional view, and an enlarged plan view of a part C in the enlarged sectional view of the part B. In the enlarged sectional view of the part B, the suction hole 104 is omitted. FIG. 5 is a sectional view of step. S16 in FIG. 2, an enlarged sectional view of a part D in the sectional view, and an enlarged plan view of a part E in the enlarged sectional view of the part D. In the enlarged sectional view of the part D, the suction hole 104 is omitted.

Specifically, FIG. 3 is an enlarged sectional view of the part A including the gate 105 of the mold. FIG. 4 is an enlarged sectional view of the part B including a parting line (end of the cavity) that is a joint between the stationary mold 101 and the movable mold 102. FIG. 5 is an enlarged sectional view of the part D including the parting line of the mold. The enlarged sectional views in FIGS. 4 and 5 show a alternate long and short dash line 109 perpendicular to the parting line of the mold. Further, FIG. 4 is an enlarged plan view of the adhesive layer 306 included in the part C in the enlarged part B. FIG. 5 is an enlarged plan view of the adhesive layer 306 included in the part E in the enlarged part D. The enlarged plan views in FIGS. 4 and 5 show a parting line 110 of the mold.

As described above, in step 14 in FIG. 3, the molten injection molding resin 106 is injected from the gate 105 into the cavity of the mold toward the adhesive layer 306. At this time, as shown in the enlarged sectional view of the part A including the gate 105 of the mold, heat from the molten injection molding resin 106 softens the adhesive layer 306 formed of thermoplastic resin, and the thermoplastic resin forming the softened adhesive layer 306 flows in synchronization with a flow of the molten injection molding resin 106 by filling of the molten injection molding resin 106. The enlarged sectional view of the part A shows the flow of the molten injection molding resin 106 by arrow 401, and the flow of the resin in the adhesive layer 306 by arrow 402. Then, with the flow 402 of the resin in the adhesive layer 306, the inorganic filler pieces 307 mixed in the adhesive layer 306 are moved in the adhesive layer 306 in synchronization with the flow 401 of the molten injection molding resin 106.

When the molten injection molding resin 106 substantially fills the cavity of the mold, in step 15 in FIG. 4, the adhesive layer 306 together with the injection molding resin 106 is cooled in the cavity of the mold. At this time, as shown in the enlarged sectional view of the part B including the parting line 110 (alternate long and short dash line 109) of the mold and the enlarged plan view of the part C in the part B, a density of the inorganic filler pieces 307 on or around the parting line 110 away from the gate 105 is higher than that of before the injection of the injection molding resin 106 because the inorganic filler pieces 307 are moved in synchronization with the flow of the molten injection molding resin 106. On the other hand, a density of the inorganic filler pieces 307 around the gate 105 is lower than that of before the injection of the injection molding resin 106 because the inorganic filler pieces 307 are moved in synchronization with the flow of the molten injection molding resin 106. Specifically, the density of the inorganic filler pieces 307 in the adhesive layer 306 of the transfer film 202 along the cavity surface of the movable mold 102 is higher at the end of the cavity than at a middle of the cavity. Thus, in the case where a relationship between the distances A and B from the gate 105 in the cavity of the mold is A<B when a density of the inorganic filler pieces 307 in a position of a distance A from the gate 105 is dA, and a density of the inorganic filler pieces 307 in a position of a distance B from the gate is dB, a relationship between the densities dA and dB of the inorganic filler pieces 307 contained in the adhesive layer 306 is dA<dB. As such, when the adhesive layer 306 is cooled together with the injection molding resin 106 filling the cavity of the mold, the density of the inorganic filler pieces 307 around the gate 105 is low, while the density of the inorganic filler pieces 307 on or around the parting line 110 of the mold is high.

After the injection molding resin 106 filling the cavity of the mold is hardened, the mold is opened in step 16 in FIG. 5, and thus the transfer film 202 adhering to the surface of the molded injection molding resin 106 is delaminated from the carrier film 201. At this time, the density of the inorganic filler pieces 307 on or around the parting line 110 of the mold, that is, in an outermost peripheral portion of the molded injection molding resin 106 is high, and a distance between the inorganic filler pieces 307 is short, while the density of the thermoplastic resin forming the adhesive layer 306 is low. Thus, in the outermost peripheral portion of the molded injection molding resin 106, adhesive strength (bonding strength) between the inorganic filler pieces 307 is low in the adhesive layer 306. Thus, when the movable mold 102 is lowered and opened, a crack is generated between a region of the adhesive layer 306 adhering to the surface of the injection molding resin 106, and a region of the adhesive layer 306 that does not adhere to the surface of the injection molding resin 106 due to a force applied to the adhesive layer 306 on or around the parting line 110 by the opening of the mold. Then, as shown in the enlarged sectional view and the enlarged plan view of step S16, the adhesive layer 306, the coloring layer 305, the anchor layer 304, and the protective layer or hard coat layer 303 are cut from the crack along a line connecting adjacent inorganic filler pieces 307 at a shortest distance to cause foil separation of the transfer film 202 on or around the parting line 110 (end of the cavity). Thus, according to Embodiment 1, the generation of a foil burr at an end or end surface of the molded product 107 is prevented. This can provide an in-mold molded product with no or few foil burrs.

When the inorganic filler pieces 307 are mixed in the adhesive layer 306, transparency of the adhesive layer 306 may be reduced. Thus, when the adhesive layer 306 needs transparency in terms of design for decorating the surface of the molded product, the adhesive layer 306 may be formed using multiple types of adhesives containing different numbers of inorganic filler pieces in such a manner that an adhesive containing no inorganic filler pieces 307 or containing a reduced number of inorganic filler pieces 307 is used in a part of the adhesive layer 306 that needs transparency, and an adhesive in which a required number of inorganic filler pieces 307 are mixed is used in a part of the adhesive layer 306 corresponding to the end or end surface of the molded product where a foil burr is easily generated.

The adhesive layer is not limited to just one layer, but may include a plurality of layers as long as the generation of a foil burr at the end or end surface of the molded product can be prevented.

Although it is not shown, in the case where an outermost layer of the transfer film in contact with the injection molding resin serves as both an adhesive layer and a coloring layer, and the outermost layer of the transfer film is formed of thermoplastic ink, the filler pieces may be mixed in the outermost layer of the transfer film to prevent the generation of a foil burr at the end or end surface of the molded product. A configuration in which an outermost layer of the transfer film serves as both an adhesive layer and a coloring layer includes a configuration in which a coloring layer formed of a single layer also serves as an adhesive layer, and a configuration in which an outermost layer in contact with injection molding resin of a coloring layer including a plurality of layers also serves as an adhesive layer.

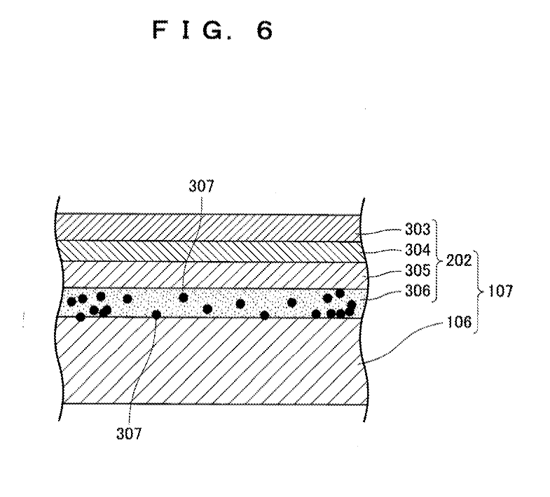

FIG. 6 is a sectional view of the in-mold molded product 107 produced using the decorative film 100 in Embodiment 1. In FIG. 6, components corresponding to components shown in FIGS. 1 to 5, 17 and 18 are denoted by the same reference numerals, and overlapping descriptions will be omitted.

In the case where the decorative film 100 including the adhesive layer 306 in which the inorganic filler pieces 307 are mixed is used, a part of the inorganic filler pieces 307 are partially embedded in the surface of the molten injection molding resin 106 in contact with the adhesive Layer 306, and the injection molding resin 106 is hardened in that state during injection molding. Thus, as shown in FIG. 6, in the obtained in-mold molded product 107, the part of the inorganic filler pieces 307 are partially embedded in the surface of the molded injection molding resin 106. This increases the surface hardness of the molded injection molding resin 106 to prevent a nick or a scratch on the surface of the molded injection molding resin 106. Specifically, a dent in the surface of the molded injection molding resin 106 is prevented.

When porous silica as the inorganic filler piece 307 is mixed in the adhesive layer 306, the surface hardness of the injection molding resin 106 is increased, and also degradation of the injection molding resin 106 by hydrolysis is prevented. This is because water in air is absorbed by the inorganic filler piece 307 (porous silica), and is not absorbed in the injection molding resin 106.

When the porous silica as the inorganic filler piece 307 is mixed in the adhesive layer 306, a reduction in quality of the stored decorative film 100 is prevented. This is because water in air is absorbed by the inorganic filler piece 307 (porous silica) mixed in the adhesive layer 306 even during storage of the decorative film, and hydrolysis of resin forming the adhesive layer 306 is prevented.

### Embodiment 2

The in-mold molded product in Embodiment 1 described above does not basically causes problems. However, in order to more satisfactorily cause foil separation at the end or end surface of the molded product, Embodiment 2 described below is more effective.

Embodiment 2 is different from Embodiment 1 described above in size of an inorganic filler piece 307 mixed in an adhesive layer. Specifically, Embodiment 2 is different from Embodiment 1 described above in that an average particle size (catalogue value) of the inorganic filler piece 307 mixed in an adhesive layer 306 of a decorative film 100 is larger than a thickness of a thickest part of the adhesive layer 306 after drying.

In Embodiment 2, as the inorganic filler piece 307, spherical silica having an average particle size (catalogue value) of 10 μm is mixed in an adhesive, and then the adhesive is used to form an adhesive layer 306 having an average thickness after drying is 4 μm. The adhesive layer 306 after drying has a thickness of about 5 μm at a thickest part. As in Embodiment 1 described above, 0.5 to 30 parts by weight of inorganic filler pieces 307 are desirably added to 100 parts by weight of adhesive in terms of viscosity.

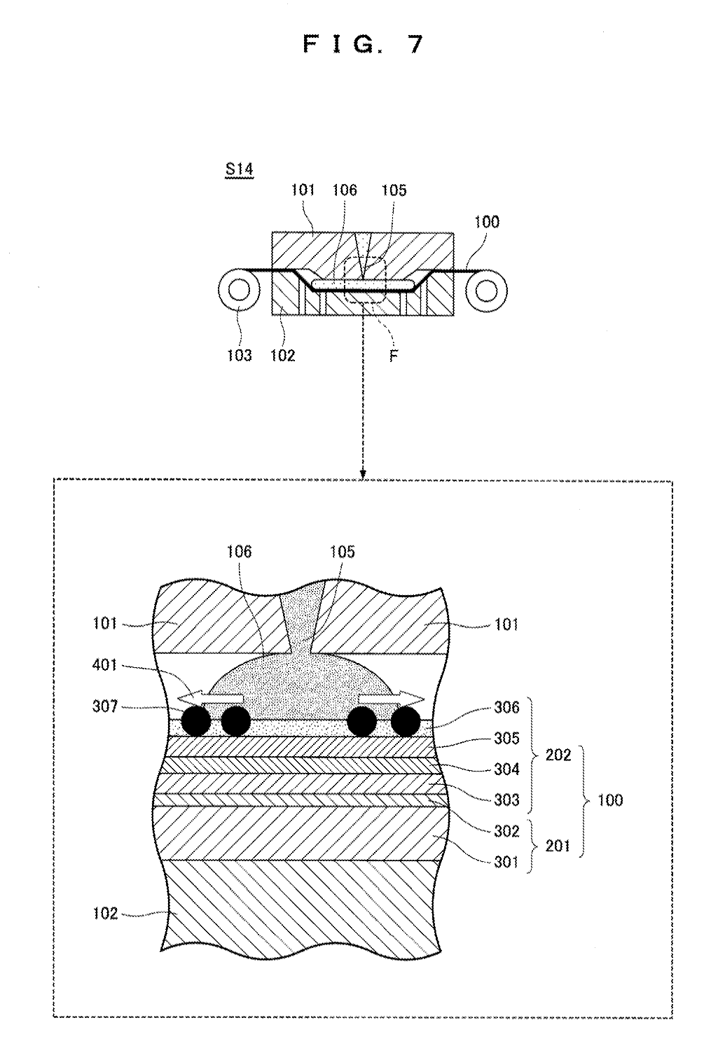

Now, with reference to FIGS. 7 to 9, Embodiment 2 will be described mainly on differences from Embodiment 1 described above. In FIGS. 7 to 9, components corresponding to components shown in FIGS. 1 to 6, 17 and 18 are denoted by the same reference numerals, and overlapping descriptions will be omitted.

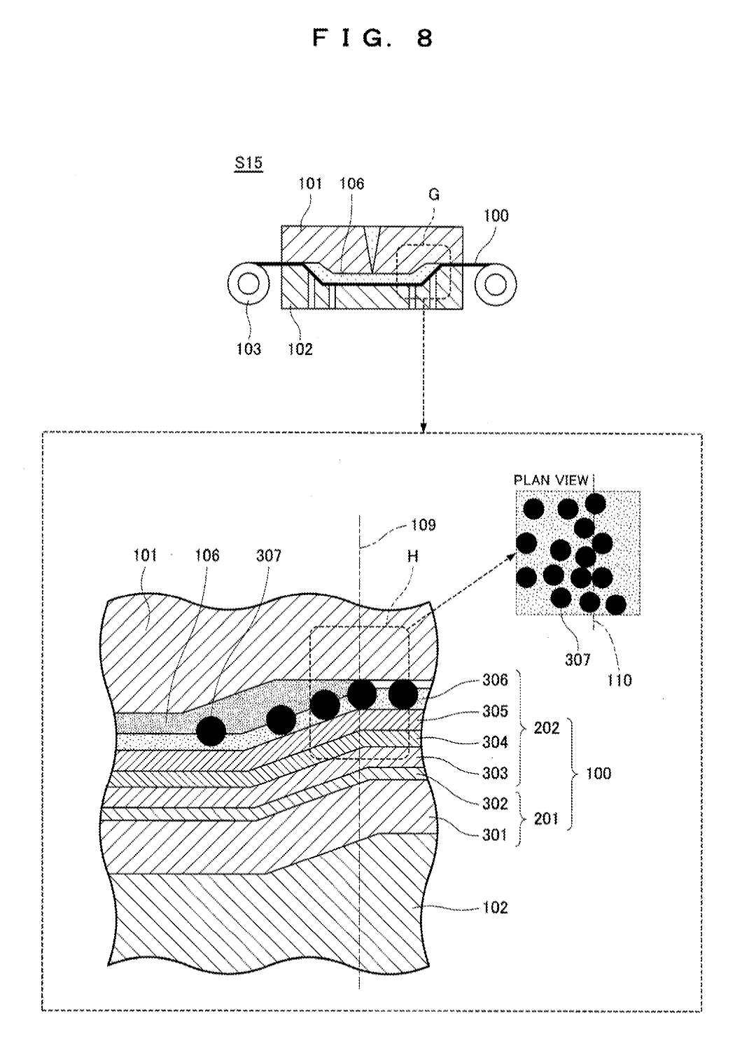

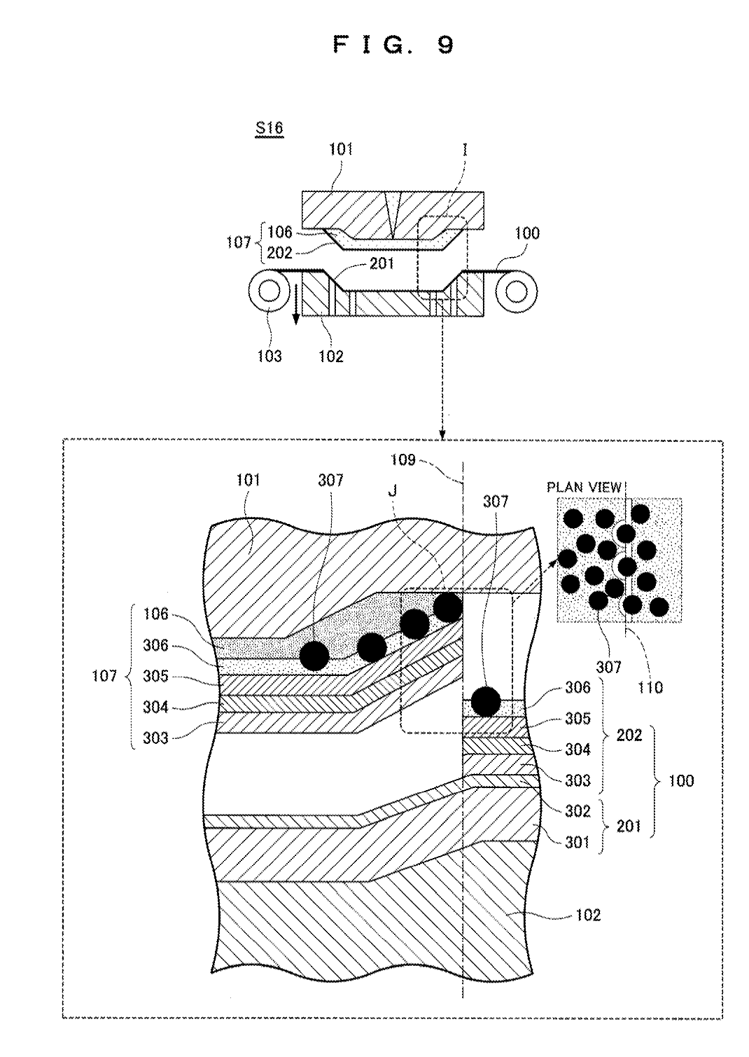

FIGS. 7 to 9 are sectional views of a part of steps of a production process of the in-mold molded product using the decorative film 100 in Embodiment 2. The process for producing the in-mold molded product having a decorated surface using the decorative film 100 in Embodiment 2 is the same as the process described in Embodiment 1, and FIGS. 7 to 9 are sectional views of steps S14, S15 and S16 described in Embodiment 1. Further, FIG. 7 is an enlarged sectional view of a part F including a gate 105 of a mold. FIG. 8 is an enlarged sectional view of a part G including a parting line (end of a cavity) that is a joint between a stationary mold 101 and a movable mold 102. In the enlarged sectional view of the part G, a suction hole 104 is omitted. FIG. 9 is an enlarged sectional view of a part I including the parting line of the mold. In the enlarged sectional view of the part I, the suction hole 104 is omitted. The enlarged sectional views in FIGS. 8 and 9 show a alternate long and short dash line 109 perpendicular to the parting line. Further, FIG. 8 is an enlarged plan view of the adhesive layer 306 included in a part H in the enlarged part G. FIG. 9 is an enlarged plan view of the adhesive layer 306 included in a part J in the enlarged part I. The enlarged plan views in FIGS. 8 and 9 show a parting line 110 of the mold.

As described in Embodiment 1, in step 14 in FIG. 7, the molten injection molding resin 106 is injected from the gate 105 into the cavity of the mold toward the adhesive layer 306. At this time, as/described in Embodiment 1, heat from the molten injection molding resin 106 softens the adhesive layer 306 formed of thermoplastic resin, and the thermoplastic resin forming the softened adhesive layer 306 flows in synchronization with a flow 401 of the molten injection molding resin 106 by filling of the molten injection molding resin 106.

In Embodiment 2, the average particle size of the inorganic filler piece 307 is sufficiently larger than the thickness of the adhesive layer 306, and thus as shown in the enlarged sectional view of the part F including the gate 105 of the mold, injection pressure of the molten injection molding resin 106 is directly applied to a part of the inorganic filler piece 307 protruding from the surface of the adhesive layer 306. Thus, the inorganic filler piece 307 more easily flows in synchronization with the flow of the molten injection molding resin 106 than in Embodiment 1 using the inorganic filler piece having a smaller average particle size than an average thickness of the adhesive layer 306.

When the molten injection molding resin 106 substantially fills the cavity of the mold, in step 15 in FIG. 8, the adhesive layer 306 is cooled together with the injection molding resin 106 filling the cavity of the mold as described in Embodiment 1. At this time, a density of the inorganic filler pieces 307 on or around the parting line 110 of the mold is higher than a density of the inorganic filler pieces 307 around the gate 105. This is because the inorganic filler pieces 307 are moved in synchronization with the flow of the molten injection molding resin 106 as described in Embodiment 1.

In Embodiment 2, the density of the inorganic filler pieces 307 on or around the parting line 110 of the mold is noticeably higher than that of in Embodiment 1 using the inorganic filler piece 307 having a smaller average particle size than an average thickness of the adhesive layer 306. This is because, as described above, a fluidity of the inorganic filler piece 307 in filling of the molten injection molding resin 106 is higher than that of in Embodiment 1. Thus, on or around the parting line 110, a distance between the inorganic filler pieces 307 is shorter than that of in Embodiment 1, and a density of thermoplastic resin forming the adhesive layer 306 is lower than that of in Embodiment 1. Thus, in step 16 in FIG. 9, when the movable mold 102 is lowered and opened to cause foil separation of the transfer film 202, a crack is more easily generated between a region of the adhesive layer 306 adhering to the surface of the injection molding resin 106, and a region of the adhesive layer 306 that does not adhere to the surface of the injection molding resin 106 than that of in Embodiment 1. This more easily causes foil separation of the transfer film 202 on or around the parting line 110 (end of the cavity) of the mold along a line connecting adjacent inorganic filler pieces 307 at a shortest distance as compared to Embodiment 1. Thus, according to Embodiment 2, the generation of a foil burr at an end or end surface of the molded product 107 is prevented as compared to Embodiment 1.

In Embodiment 2, the inorganic filler piece 307 having an average particle size larger than a thickness of a thickest part of the adhesive layer 306 after drying is used, and thus the inorganic filler piece 307 easily protrudes from the surface of the adhesive layer 306. Thus, the inorganic filler piece 307 and the stationary mold 101 easily come into contact with each other at the joint surface between the stationary mold 101 and the movable mold 102, thereby reducing the direct contact between the adhesive layer 306 and the stationary mold 101. See the partial enlarged sectional view of step S15 in FIG. 8. Accordingly, even when a softening point of the thermoplastic resin forming the adhesive layer 306 is lower than a mold temperature, softening of the adhesive layer 306 is prevented at the joint surface between the stationary mold 101 and the movable mold 102 to prevent fusion of the adhesive layer 306 with the stationary mold 101.

According to the decorative film 100 of Embodiment 2, blocking is prevented even if the decorative film 100 is rolled up. The blocking is a phenomenon in which when the decorative film 100 is rolled up, rolling pressure is applied to the decorative film 100, and thus the adhesive layer 306 adheres to the base film 301. With reference to FIG. 10, this effect will be described below.

FIG. 10 is a side view of the rolled-up decorative film 100 in an upper left, and a front view of the rolled-up decorative film 100 in an upper right. FIG. 10 is also an enlarged sectional view of a part K in the front view of the decorative film 100. In FIG. 10, components corresponding to components shown in FIGS. 1 to 9, 17 and 18 are denoted by the same reference numerals, and overlapping descriptions will be omitted.

As in Embodiment 2, when the inorganic filler piece 307 having an average particle size (catalogue value) larger than a thickness of a thickest part of the adhesive layer 306 after drying is used, the inorganic filler piece 307 mixed in the adhesive layer 306 easily comes into contact with the base film 301 in the rolled-up decorative film 100 as shown in the enlarged sectional view in FIG. 10, thereby reducing the direct contact between the adhesive layer 306 and the base film 301. This prevents blocking that easily occurs when the adhesive layer 306 has tackiness (adhesion).

### Embodiment 3

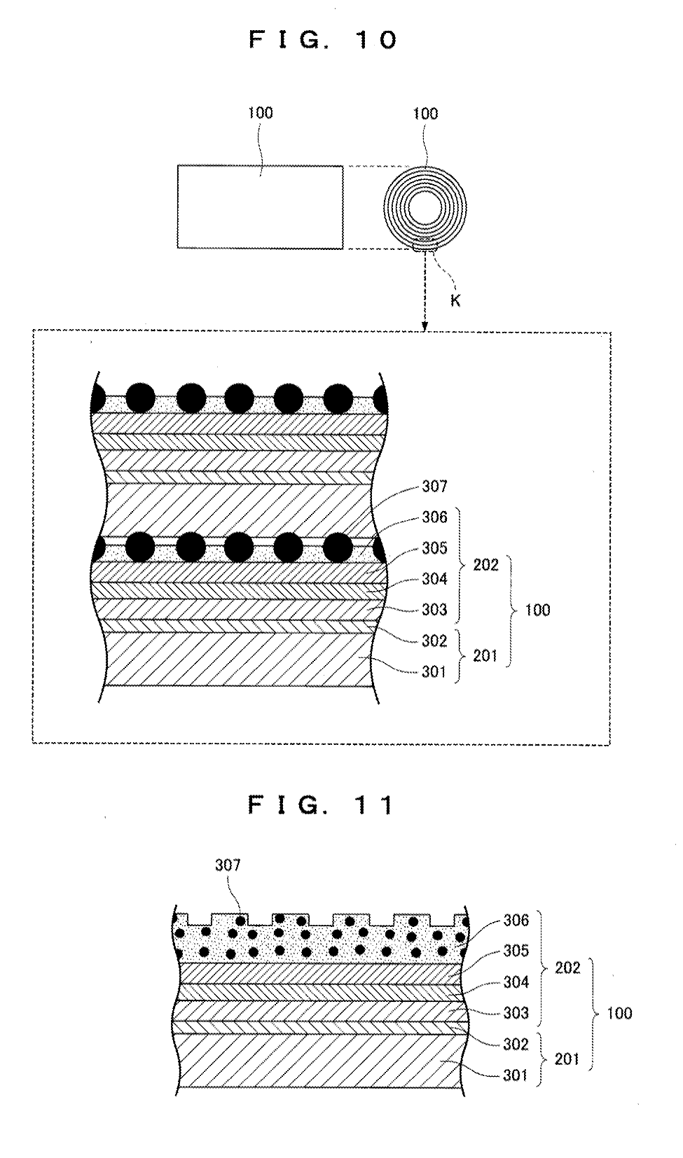

FIG. 11 shows a layer configuration of a decorative film for in-mold molding in Embodiment 3 of the present invention. In FIG. 11, components corresponding to components shown in FIGS. 1 to 10, 17 and 18 are denoted by the same reference numerals, and overlapping descriptions will be omitted.

As shown in FIG. 11, Embodiment 3 is different from Embodiment 1 described above in that a surface of the adhesive layer 306 has irregularities. As such, the surface of the adhesive layer 306 has irregularities, and thus an inorganic filler piece 307 more easily flows in synchronization with a flow of molten injection molding resin 106 during injection molding than that of in Embodiment 1 even without using an inorganic filler piece having an average particle size (catalogue value) larger than a thickness of a thickest part of the adhesive layer 306 after drying as in Embodiment 2. Thus, a density of the inorganic filler pieces 307 on or around a parting line of a mold can be higher than that of in Embodiment 1.

Now, Embodiment 3 will be described mainly on differences from Embodiment 1 described above.

In Embodiment 3, a larger number of inorganic filler pieces 307 are added to the adhesive layer 306 than that of in Embodiment 1. Also, an inorganic filler piece 307 is selected having a larger average particle size (catalogue value) within a range of average particle sizes smaller than an average thickness of the adhesive layer 306 after drying. This increases surface roughness of the adhesive layer 306 after drying, and more noticeably provides irregularities in the surface of the adhesive layer 306 as shown in FIG. 11.

For example, when an adhesive layer 306 having an average thickness after drying of 4 μm, a thickness of a thickest part of 5 μm, and a thickness of a thinnest part of 3.5 μm is formed, spherical silica having an average particle size of 2 μm is used as the inorganic filler piece 307, and 3 or more parts by weight of inorganic filler pieces 307 are mixed in 100 parts by weight of adhesive, thereby obtaining more noticeable irregularities. When the adhesive layer 306 having an average thickness after drying of 4 μm, a thickness of a thickest part of 5 μm, and a thickness of a thinnest part of 3.5 μm is formed, the average particle size of the inorganic filler piece 307 is preferably selected from a range of 0.2 μm to 4 μm for forming irregularities in the surface of the adhesive layer 306.

The above-described values of the thickness of the adhesive layer 306, the average particle size of the inorganic filler piece 307, and the number of added inorganic filler pieces 307 are examples. The thickness of the adhesive layer 306, the average particle size of the inorganic filler piece 307, and the number of added inorganic filler pieces 307 are not limited to the above-described values as long as the generation of a foil burr at the end or end surface of the molded product can be prevented, and irregularities can be formed in the surface of the adhesive layer 306.

The production process of the in-mold molded product using the decorative film 100 described above is the same as the production process described in Embodiment 1.

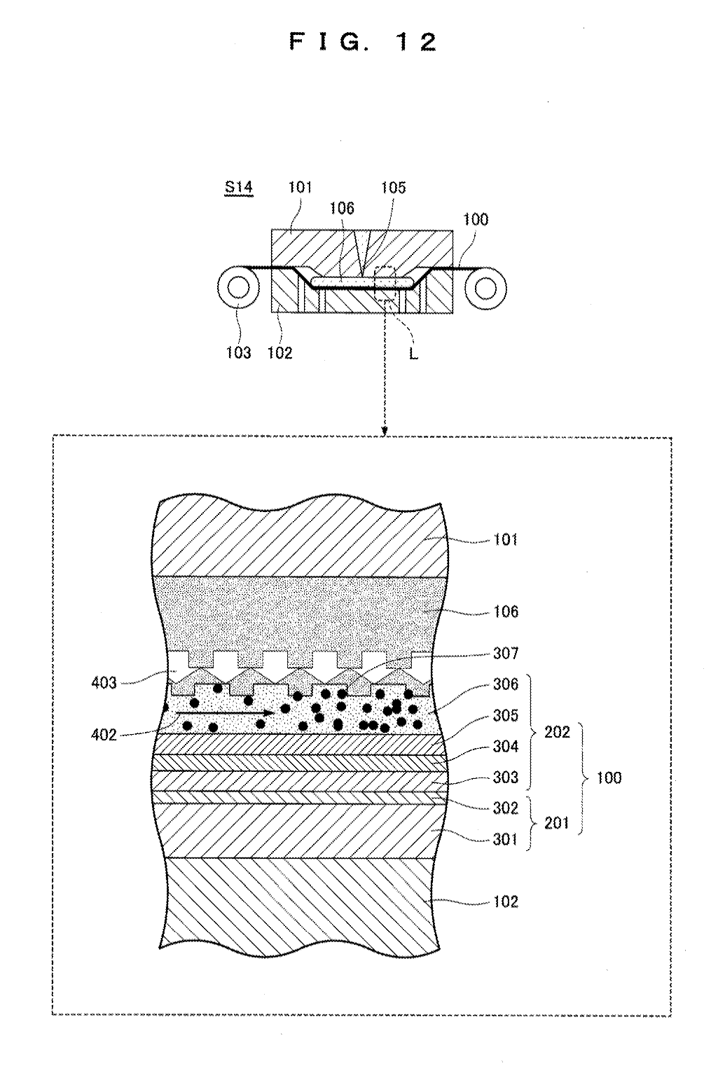

FIG. 12 is a sectional view of step S14 described in Embodiment 1, and an enlarged sectional view of a part L in the sectional view. In FIG. 12, components corresponding to components shown in FIGS. 1 to 11, 17 and 18 are denoted by the same reference numerals, and overlapping descriptions will be omitted.

As described in Embodiment 1, in step 14, the molten injection molding resin 106 is injected from the gate 105 into the cavity of the mold toward the adhesive layer 306. At this time, as shown in the partial enlarged sectional view in FIG. 12, the surface of the adhesive layer 306 of the decorative film 100 has irregularities, and the molten injection molding resin 106 fits into recesses in the irregularities in the adhesive layer 306 to increase an area of an interface between the adhesive layer 306 and the injection molding resin 106. Thus, heat from the molten injection molding resin 106 is well transferred to the decorative film 100 to increase the flow of the thermoplastic resin in the adhesive layer 306 due to the heat from the injection molding resin 106. In the partial enlarged sectional view in FIG. 12, the heat transferred from the molten injection molding resin 106 to the decorative film 100 is shown by arrow 403.

As such, since the heat transfer action from the molten injection molding resin 106 is increased, the inorganic filler pieces 307 more easily flow in the adhesive layer 306 than that of in Embodiment 1. Thus, the inorganic filler pieces 307 are more easily moved in synchronization with the flow of the molten injection molding resin 106, thereby more noticeably increasing the density of the inorganic filler pieces 307 on or around the parting line of the mold than that of in Embodiment 1. Accordingly, on or around the parting line of the mold, a distance between the inorganic filler pieces 307 is shorter than that of in Embodiment 1, and the density of the thermoplastic resin forming the adhesive layer 306 is lower than that of in Embodiment 1. This more easily causes, as in Embodiment 2, foil separation of the transfer film 202 on or around the parting line 110 (end of the cavity) of the mold along a line connecting adjacent inorganic filler pieces 307 at a shortest distance when the mold is opened to cause foil separation of the transfer film 202 in step 16, than that of in Embodiment 1.

For the above reason, according to Embodiment 3, the generation of a foil burr is further prevented at an end or end surface of the molded product 107 as compared to Embodiment 1. Further, in Embodiment 3, the surface of the adhesive layer 306 has irregularities, and the decorative film 100 is thin in positions corresponding to recesses of the irregularities in the surface of the adhesive layer. Thus, a crack is easily generated from the thin parts to more easily cause foil separation at the end or end surface of the molded product.

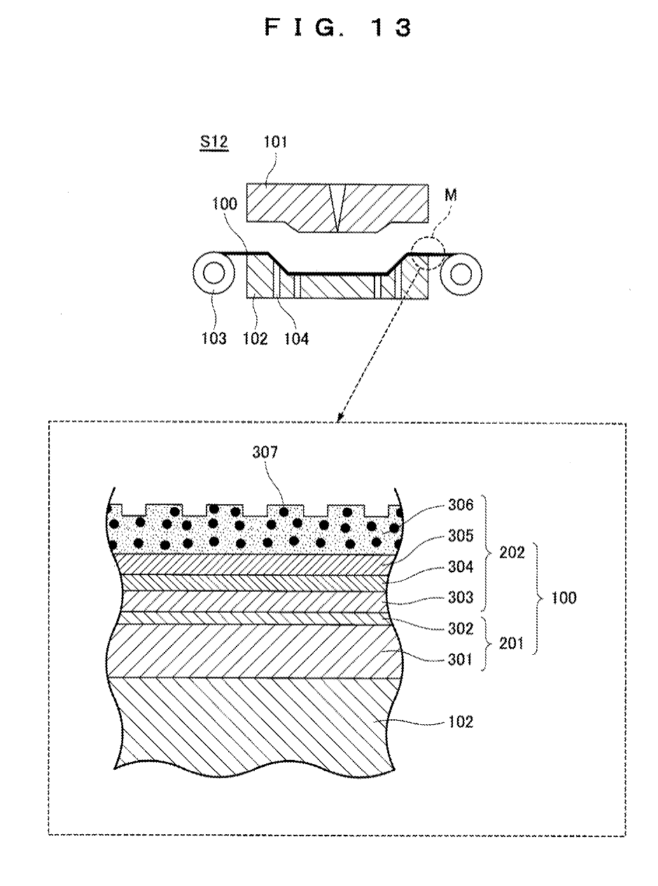

According to Embodiment 3, even when a mold temperature is higher than a softening point of the thermoplastic resin forming the adhesive layer 306, softening of the adhesive layer 306 at the joint surface between the stationary mold 101 and the movable mold 102 is prevented, thereby preventing fusion of the adhesive layer 306 with the stationary mold 101. With reference to FIGS. 13 to 15, this effect will be described below. In FIGS. 13 to 15, components corresponding to components shown in FIGS. 1 to 12, 17 and 18 are denoted by the same reference numerals, and overlapping descriptions will be omitted.

FIGS. 13, 14 and 15 are sectional views of steps S12, S14, and S16 described in Embodiment 1. Further, FIGS. 13, 14, and 15 are enlarged sectional views of parts M, N and O including a joint surface between the stationary mold 101 and the movable mold 102 (outer peripheral portion of the mold) in the sectional views of steps S12, S14, and S16.

As described in Embodiment 1, in step S12 in FIG. 13, the decorative film 100 is sucked through a suction hole 104 opened in a cavity surface of the movable mold 102 to mount the decorative film 100 to the cavity surface of the movable mold 102. Since step S12 is performed before clamping, as shown in the enlarged sectional view of the part M, the irregularities in the surface of the adhesive layer 306 at the outer peripheral portion of the mold keeps a certain shape.

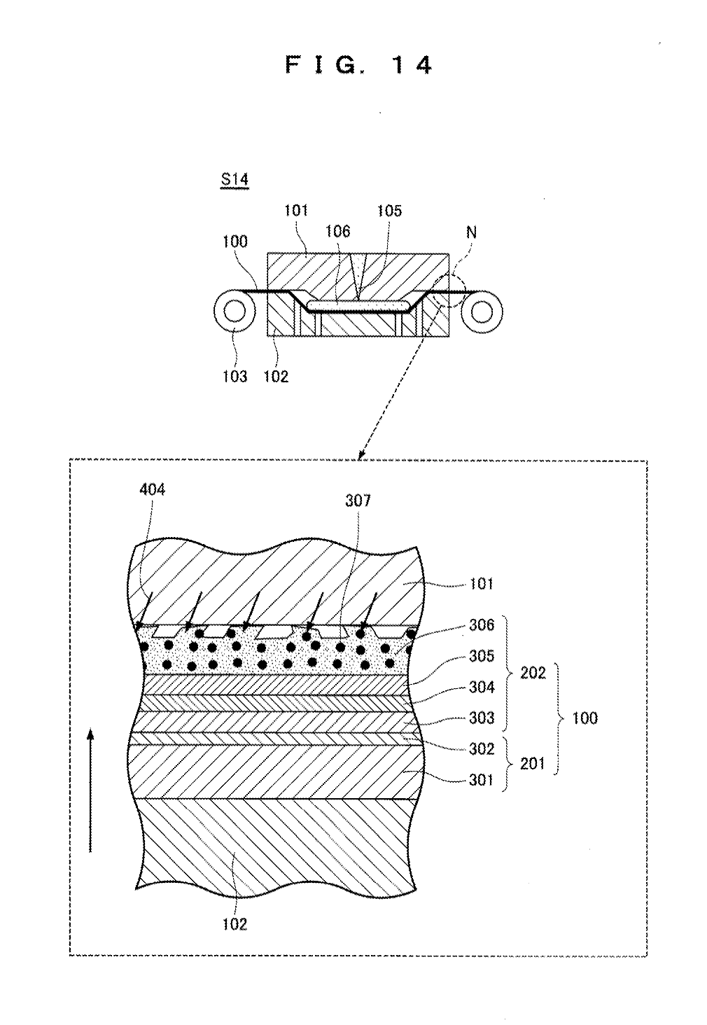

In step S14 shown in FIG. 14, as described in Embodiment 1, the molten injection molding resin 106 is injected from the gate 105 into the mold toward the adhesive layer 306. Step S14 is performed after clamping. Thus, in step S14, stress from the stationary mold 101 and the movable mold 102 is applied most to the decorative film 100 at the outer peripheral portion of the mold by clamping pressure. At this time, the surface of the adhesive layer 306 has irregularities, and as shown in the enlarged sectional view of the part N, a pressuring force by the clamping pressure is distributed and applied to projections of the adhesive layer 306. Thus, the irregularities in the adhesive layer 306 are not completely crushed but are merely deformed. In the enlarged sectional view of the part N, the pressuring force by the clamping pressure is shown by arrow 404. Thus, after the mold is opened in step S16 in FIG. 15, the irregularities in the adhesive layer 306 at the outer peripheral portion of the mold remains deformed as shown in the enlarged sectional view of the part O.

As described above, according to Embodiment 3, even after clamping, the irregularities in the adhesive layer 306 are not completely crushed, but the projections and the recesses remain. Thus, the projections remaining uncrushed reduce a contact area between the adhesive layer 306 and the stationary mold 101 at the outer peripheral portion of the mold. Further, an air space formed by the recesses remaining uncrushed provides a heat insulating effect. Therefore, even under a molding condition in which a mold temperature is higher than a softening point of the thermoplastic resin forming the adhesive layer 306, transfer of heat at the mold temperature from the stationary mold 101 to the adhesive layer 306 at the outer peripheral portion of the mold is prevented, thereby preventing fusion of the adhesive layer 306 with the stationary mold 101.

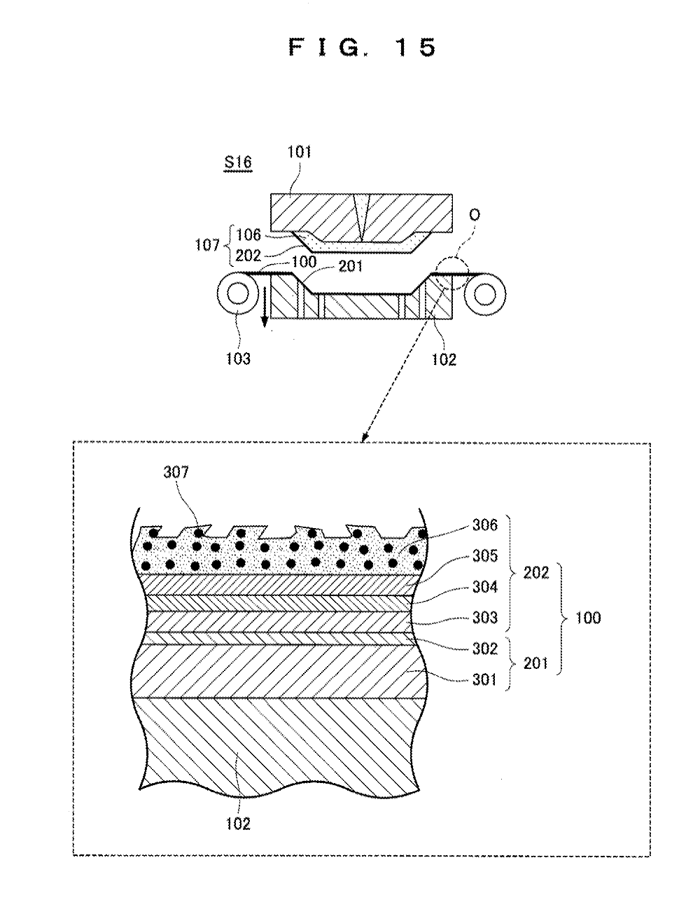

Also, according to the decorative film 100 of Embodiment 3, blocking is prevented even if the decorative film 100 is rolled up. With reference to FIG. 16, this effect will be described below.

FIG. 16 is a side view of the rolled-up decorative film 100 in an upper left, and a front view of the rolled-up decorative film 100 in an upper right. FIG. 16 is also an enlarged sectional view of a part P in the front view of the decorative film 100. In FIG. 16, components corresponding to components shown in FIGS. 1 to 15, 17 and 18 are denoted by the same reference numerals, and overlapping descriptions will be omitted.

As in Embodiment 3, in the case where the surface of the adhesive layer 306 has irregularities, as shown in the enlarged sectional view in FIG. 16, the roiled-up decorative film 100 reduces a contact area between the adhesive layer 306 and the base film 301. This prevents blocking that easily occurs when the adhesive layer 306 has tackiness (adhesion).

In the above embodiments, the inorganic filler piece is described as an example of a filter piece contained in the transfer film, but an organic filler piece may be used as long as the filler piece can prevent the generation of a foil burr at an end or end surface of the molded product.

Some exemplary embodiments of the present invention have been described in detail, but those skilled in the art would easily understand that various changes may be made in the exemplary embodiments without departing from the novel teaching of the present invention and the advantages of the present invention. Therefore, such various changes are intended to fall within the scope of the present invention.

What is claimed is:

1. An in-mold molded product comprising:
molded resin;
a transfer film including an adhesive layer in contact with the molded resin; and
a plurality of filler pieces, at least a part of volumes of the filler pieces being contained in the adhesive layer.

2. The in-mold molded product according to claim 1, wherein a density of the filler pieces at an end of the transfer film is higher than a density of the filler pieces at a middle of the transfer film.

3. The in-mold molded product according to claim 1, wherein an average particle size of the plurality of filler pieces is larger than a thickness of a thickest part of the adhesive layer of the transfer film.

4. The in-mold molded product according to claim 1, wherein the adhesive layer of the transfer film has an irregular surface.

5. The in-mold molded product according to claim 1, wherein at least a part of a volume of at least one of the filler pieces is embedded in the molded resin.

6. The in-mold molded product according to claim 1, wherein at least a part of the plurality of filler pieces are porous filler pieces.

7. The in-mold molded product according to claim 1, wherein at least a part of the plurality of filler pieces are inorganic filler pieces.

8. An in-mold molding film comprising:
a carrier film;
a transfer film including an adhesive layer and formed on the carrier film; and
a plurality of filler pieces, at least a part of volumes of the filler pieces being contained in the adhesive layer.

9. The in-mold molding film according to claim 8, wherein an average particle size of the plurality of filler pieces is larger than a thickness of a thickest part of the adhesive layer of the transfer film.

10. The in-mold molding film according to claim 8, wherein the adhesive layer of the transfer film has an irregular surface.

11. The in-mold molding film according to claim 8, wherein at least a part of the plurality of filler pieces are porous filler pieces.

12. The in-mold molding film according to claim 8, wherein at least a part of the plurality of filler pieces are inorganic filler pieces.

13. The in-mold molding film according to claim 8, wherein the transfer film sequentially includes a protective layer or hard coat layer, an anchor layer, a coloring layer, and the adhesive layer, and
the carrier film sequentially includes a base film, and a delamination layer.

14. A method for producing an in-mold molded product comprising the steps of:
placing an in-mold molding film including a carrier film, a transfer film including an adhesive layer and formed on the carrier film, and a plurality of filler pieces, at least a part of volumes of the filler pieces being contained in the adhesive layer, between a first mold and a second mold;
clamping the first mold and the second mold;
pouring resin into a cavity formed by clamping the first mold and the second mold;
cooling the resin poured into the cavity;
opening the first mold and the second mold to delaminate the transfer film in contact with the molded resin from the carrier film; and
obtaining an in-mold molded product including a surface and the transfer film on the surface,
wherein the obtained in-mold molded product includes the molded resin, the transfer film including the adhesive layer in contact with the molded resin, and the plurality of filler pieces, at least a part of volumes of the filler pieces being contained in the adhesive layer.

15. The method for producing an in-mold molded product according to claim 14, wherein a density of the filler pieces in the transfer film along a cavity surface of one of the first mold and the second mold is higher at an end of the cavity than at a middle of the cavity in cooling the resin poured into the cavity.

16. The method for producing an in-mold molded product according to claim 14, wherein in a case where a relationship between distances A and B from a gate for pouring the resin into the cavity is A<B in the cavity when a density of the filler pieces in a position of the distance A from the gate is dA, and a density of the filler pieces in a position of the distance B from the gate is dB, a relationship between the densities dA and dB of the filler pieces is dA<dB in cooling the resin poured into the cavity.

17. The method for producing an in-mold molded product according to claim 14, wherein the transfer film is cut between adjacent filler pieces at the end of the cavity when the first mold and the second mold are opened.

18. The method for producing an in-mold molded product according to claim 14, wherein at least a part of a volume of at least one of the filler pieces is embedded in the resin poured into the cavity.
